(19) United States
(12) Patent Application Publication
(10) Pub. No.: US 2024/0343422 A1
(43) Pub. Date: Oct. 17, 2024

(54) SPHERICAL DRONE AND CONTROL METHOD THEREOF

(71) Applicant: GANG YAO, SHENZHEN (CN)

(72) Inventor: GANG YAO, SHENZHEN (CN)

(21) Appl. No.: 18/313,497

(22) Filed: May 8, 2023

(30) Foreign Application Priority Data
Apr. 14, 2023 (CN) 202320845415.3

(51) Int. Cl. B64U 20/75; B64U 20/80; B64U 30/24; B64U 50/19; B64U 70/10

(52) U.S. Cl. CPC B64U 20/75; B64U 20/80; B64U 30/24; B64U 50/19; B64U 70/10

(57) ABSTRACT

A spherical drone and a control method thereof relate to a field of drones. The spherical drone includes a main shell defines an accommodating space, an inner support arranged in the accommodating space, a main control board, a power supply, a motor, a fixing shaft, an upper blade and an lower blade rotatably arranged on the fixing shaft, and a first crown gear and a second crown gear arranged on the inner support. Slotted holes are defined on the main shell. The first crown gear and the second crown gear are sleeved on the fixing shaft. The upper blade is fixed on the first crown gear. The lower blade is fixed on the second crown gear. The motor drives the first crown gear and the second crown gear to rotate, so as to simultaneously drive the upper blade and the lower blade to rotate.

### TECHNICAL FIELD

The present disclosure relates to a technical field of spherical drones, and in particular to a spherical drone with stable flight and a control method thereof.

### BACKGROUND

At present, there are various kinds of aircraft on the market. Functions and styles of the aircraft are different, but working mechanisms of the aircraft are basically the same. Specifically, the aircraft is generally driven by an internal motor to rotate internal blades, making the aircraft to rise, so as to control take-off and a flight direction of the aircraft.

However, conventional spherical drones have a large spin speed during a flight process, and flight stability is not good. The conventional spherical drones are easy to deviate when the conventional spherical drones are controlled to fly according to a certain trajectory. Chinese patent document 202020575801.1 discloses a gyratory flying ball, whose motor only drives blades of a blade structure to rotate, and rotating blades arranged on an inner support are driven to rotate by wind generated during rotation of the blades. During the flight process, a lift force of the gyratory flying ball is hardly controlled, and a spin speed of the gyratory flying ball is large, so that it is difficult to control the gyratory flying ball to fly according to a certain trajectory, and the flight stability is not good.

### SUMMARY

A purpose of the present disclosure is to solve defects in the prior art. The present disclosure provides a spherical drone with stable flight. An upper blade and a lower blade of the spherical drone are powered, and a spin speed of the spherical drone is low, making flight of the spherical drone stable and making it easy to control the spherical drone to fly along different trajectories.

To achieve the above purpose, the present disclosure provides the spherical drone. The spherical drone comprises a main shell defines an accommodating space, an inner support arranged in the accommodating space, a main control board mounted on the inner support, a power supply mounted on the inner support, a motor mounted on the inner support, a fixing shaft arranged on the inner support, an upper blade and an lower blade rotatably arranged on the fixing shaft, and a first crown gear and a second crown gear arranged on the inner support.

The main shell is spherical. Slotted holes are defined on the main shell. The accommodating space is communicated with an outside through the slotted holes. A center of the fixing shaft coincides with a center of the main shell. The first crown gear and the second crown gear are sleeved on the fixing shaft. The upper blade is fixed on a top portion of the first crown gear. The lower blade is fixed at a bottom portion of the second crown gear. The motor drives the first crown gear and the second crown gear to rotate, so as to simultaneously drive the upper blade and the lower blade to rotate. The upper blade and the lower blade of the spherical drone are driven to rotate by the motor, so that the spin speed of the spherical drone is low during a flight process. Therefore, the flight of the spherical drone is stable and it is easy to control the spherical drone to fly along different trajectories.

In one embodiment, the spherical drone further comprises a speed clutch gear arranged on the bottom portion of the second crown gear. The speed clutch gear is sleeved on the fixing shaft. The lower blade is fixed on a bottom portion of the speed clutch gear. The lower blade does not rotate when the spherical drone flies in a low speed, which improves stability of the spherical drone during the flight process.

In one embodiment, the speed clutch gear comprise a base and a shaft body. A fixing groove is defined on the base. The base is sleeved on the fixing shaft. The shaft body is arranged in the fixing groove and is sleeved on the fixing shaft. The shaft body is fixed on the bottom portion of the second crown gear. Mounting portions are arranged on two sides of the shaft body. Two sliding blocks are one-to-one sleeved on the mounting portions. A fixing attaching portion is arranged on a bottom portion of the base. The lower blade is arranged on the fixing attaching portion. When a rotating speed of the shaft body is low, a gap is defined between an outer side of each of the sliding blocks and the base. When the rotating speed of the shaft body is high, each of the sliding blocks slides out along a direction of a corresponding mounting portion. When the sliding blocks slide to predetermined positions, an inner side of each of the sliding blocks is fixed on the corresponding mounting portion, and the outer side of each of the sliding blocks abuts against an inner wall of the fixing groove, so that the base is driven to rotate.

In one embodiment, each of the sliding blocks and the corresponding mounting portion are magnetically attracted to each other.

In one embodiment, the spherical drone further comprises a reset device arranged between each of the sliding blocks and the inner wall of the fixing groove. Each reset device is configured to reset a corresponding sliding block.

In one embodiment, the spherical drone further comprises a light bar arranged in the accommodating space and a fixing support arranged in the accommodating space. A first end of the fixing support is sleeved on the fixing shaft and is arranged on a top portion of the inner support. A second end of the fixing support is fixed on the inner support. The light bar is fixed on the fixing support. Therefore, the light bar is easy to mount. When in use, the spherical drone is able to emit colorful light.

In one embodiment, the upper blade and the lower blade comprise rotating blades. The rotating blades of the upper blade and the rotating blades of the lower blade are respectively inclined along a vertical direction of the main shell. An inclined direction of the rotating blades of the upper blade is opposite to an inclined direction of the rotating blades of the lower blade, which improves a lift force of the spherical drone during the flight process.

In one embodiment, an accommodating cavity is defined in the inner support. The main control board, the power supply, the motor, the first crown gear, and the second crown gear are arranged in the accommodating cavity.

In one embodiment, the spherical drone further comprises a charging interface arranged on a side wall of the inner support. The charging interface is electrically connected to the power supply.

In one embodiment, the inner support is a cross-shaped structure. A main cavity is defined in a middle portion of the inner support. Four accommodating grooves are respectively defined on four corners of the inner support. The four accommodating grooves are communicated with the main cavity. The first crown gear and the second crown gear are arranged in the main cavity. The motor, the main control board, the power supply, and the charging interface are respectively mounted in the four accommodating grooves. As a result, gravity of the spherical drone is balanced, which improves the stability of the spherical drone during the flight process.

In one embodiment, the motor and the power supply are respectively arranged in a first accommodating groove and a second accommodating groove. The first accommodating groove and the second accommodating groove are defined on a first column of the inner support. The main control board and the charging interface are arranged in a third accommodating groove and a fourth accommodating groove. The third accommodating groove and the fourth accommodating groove are defined on a second column of the inner support.

In one embodiment, the inner support comprises an upper support and a lower support. The upper support and the lower support are fastened to form the accommodating cavity.

In one embodiment, positioning columns are arranged on the upper support. Positioning holes matched with the positioning columns are defined on the lower support.

In one embodiment, hook portions are arranged on the upper support. Clipping portions matched with the hook portion are arranged on the lower support.

In one embodiment, a first fixing portion is arranged on an inner top portion of the main shell. A second fixing portion is arranged on an inner bottom portion of the main shell. The first fixing portion and the second fixing portion are arranged in the accommodating space. Both of the first fixing portion and the second fixing portion comprise a fixing hole. Two ends of the fixing shaft are respectively fixed in the fixing hole of the first fixing portion and the fixing hole of the second fixing portion, so that the fixing shaft is fixedly mounted.

In one embodiment, the main shell comprises an upper shell and a lower shell. The slotted holes are defined on the upper shell and the lower shell. The upper shell is fastened to the lower shell to form the accommodating space. The first fixing portion is arranged on the upper shell. The second fixing portion is arranged on the lower shell.

In one embodiment, the slotted holes are orthohexagonal holes.

In one embodiment, positioning fixing columns are arranged at intervals along an edge of the upper shell. Positioning fixing portions matched with the positioning fixing columns are arranged at intervals along an edge of the lower shell. A threaded hole is defined on each of the positioning fixing columns. An abutting portion is defined in each of the positioning fixing portions. When the spherical drone is assembled in place, a screw or a bolt passes through each of the positioning fixing portions and is fixed in a corresponding threaded hole. A head of each screw or a head of each bolt abuts against a corresponding abutting portion, so that the upper shell is fixed to the lower shell.

The present disclosure further provides a control method of the spherical drone mentioned above. The control method comprises any one of steps:
placing the spherical drone horizontally perpendicular to ground, releasing the spherical drone in a rotating state, placing a palm of a human body at a position of 1-5 cm below a bottom portion of the spherical drone, so that the spherical drone is suspended in the palm; slowly moving the palm, so that the spherical drone moves along with the palm;
holding the spherical drone with one hand, placing the spherical drone horizontally; titling the spherical drone by 10-70° with respect to a target position; releasing the spherical drone in the rotating state, so that the spherical drone flies to the target position
holding the spherical drone with the one hand, tilting the spherical drone by 10-70° towards a lower left direction or a lower right direction, enabling the spherical drone to fly away towards a left front direction or a right front direction, so that the spherical drone flies back to another target position along an offset direction;
holding the spherical drone with the one hand; throwing the spherical drone in an upward direction of 10-50°; so that the spherical drone flies back according to a downward direction opposite to the upward direction; and
holding the spherical drone with the one hand, tilting the spherical drone by 10-50° towards the left front direction or the right front direction, enabling the spherical drone to fly away towards the left front direction or the right front direction, so that the spherical drone flies back to another target position along the offset direction.

Compared with the prior art, in the present disclosure, the first crown gear and the second crown gear are used, so that the motor drives the upper blade and the lower blade to rotate simultaneously. Therefore, both the upper blade and the lower blade are driven during the flight process, which makes the spin speed of the spherical drone spin low, make the flight more stable, and makes it easy to control the spherical drone to fly along different trajectories.

The speed clutch gear is arranged between the second crown gear and the lower blade, so that when the motor drives the first crown gear and the second crown gear to rotate simultaneously, if a speed of the motor is low, only the upper blade rotates and the lower blade does not rotate. As the speed of the motor increases and reaches a relative high speed, the lower blade rotates in a direction opposite to the upper blade at a same frequency. Therefore, the lift force of the spherical drone is increased for flight, and the flight of the spherical drone is stable and the stability of the control is improved.

The inner support is the cross-shaped structure to form the four accommodating grooves. The motor and the power supply are respectively arranged in the first accommodating groove and the second accommodating groove. The first accommodating groove and the second accommodating groove are defined on the first column of the inner support. The main control board and the charging interface are arranged in the third accommodating groove and the fourth accommodating groove. The third accommodating groove and the fourth accommodating groove are defined on the second column of the inner support. By such arrangements, installations of the motor, the main control board, the power supply, and the charging interface on the inner support are facilitated, and a gravity balance of the spherical drone is facilitated. A gravity of the inner support is balanced after installing the motor, the main control board, the power supply, and the charging interface, which effectively avoids eccentricity of the spherical drone during the flight process due to an unbalanced gravity.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a structural schematic diagram of a spherical drone with stable flight of the present disclosure.

FIG. 2 is an exploded schematic diagram of the spherical drone with stable flight of the present disclosure.

FIG. 3 is an exploded schematic diagram of an upper blade, a lower blade, and an inner support of the present disclosure.

FIG. 4 is an exploded schematic diagram of the inner support and internal components thereof of the present disclosure.

FIG. 5 is another exploded schematic diagram of the inner support and the internal components thereof of the present disclosure.

FIG. 6 is a structural schematic diagram of a speed clutch gear of the present disclosure.

FIG. 7 is a cross-sectional schematic diagram of the spherical drone with stable flight of the present disclosure.

FIG. 8 is another cross-sectional schematic diagram of the spherical drone with stable flight of the present disclosure.

In the drawings:

1—upper blade; 2—lower blade; 3—main control board; 4—power supply; 5—motor; 51—driving gear; 6—fixing shaft; 7—first crown gear.; 8—second crown gear; 9 —speed clutch tooth; 91—base; 911—fixing groove; 912—fixing attaching portion.; 92—shaft body; 921—mounting portion; 93—sliding block; 11—fixing support; 12—charging interface; 13—light bar; 10—main shell; 101—upper shell; 1011—positioning fixing column; 102—lower shell; 1021—positioning fixing portion; 103—sloted hole; 20—inner support; 201—upper support; 2011—clipping portion; 202—lower support; 2021—hook portion; 203—accommodating cavity; 2031—main cavity; 2032—accommodating groove.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

It should be noted that all directional indications in the embodiments of the present disclosure (such as up, down, left, right, front, back, etc.) are only used to explain the relative position relationship the motion situation, etc. between the components under a certain specific posture (as shown in the drawings), and if the specific posture changes, the directional indications also change accordingly.

It should be noted in the description of the present disclosure that, unless otherwise regulated and defined, terms such as “connection” and “fix” shall be understood in broad sense, and for example, may refer to fixed connection or detachable connection or integral connection,, may refer to mechanical connection or electrical connection, and may refer to direct connection or indirect connection through an intermediate medium or inner communication of two elements. For those of ordinary skill in the art, the meanings of the above terms in the present disclosure may be understood according to concrete conditions.

It should be understood in the embodiments of the present disclosure that terms such as “first” and “second” are only used for the purpose of description, rather than being understood to indicate or imply relative importance or hint the number of indicated technical features. Thus, the feature limited by “first” and “second” can explicitly or impliedly include one or more features. In addition, the term “and/or” depict relationship between associated objects and there are three relationships thereon. For example, A and/or B may indicate A exists alone, A and B exist at the same time, and B exists alone. In addition, the technical solutions between the various embodiments may be combined with each other, but the combination should be realized by those skilled in the art. When the combination of the technical solutions is contradictory or cannot be implemented, it should be considered that the combination of the technical solutions does not exist or is not within the protection scope of the present disclosure.

### Embodiment 1

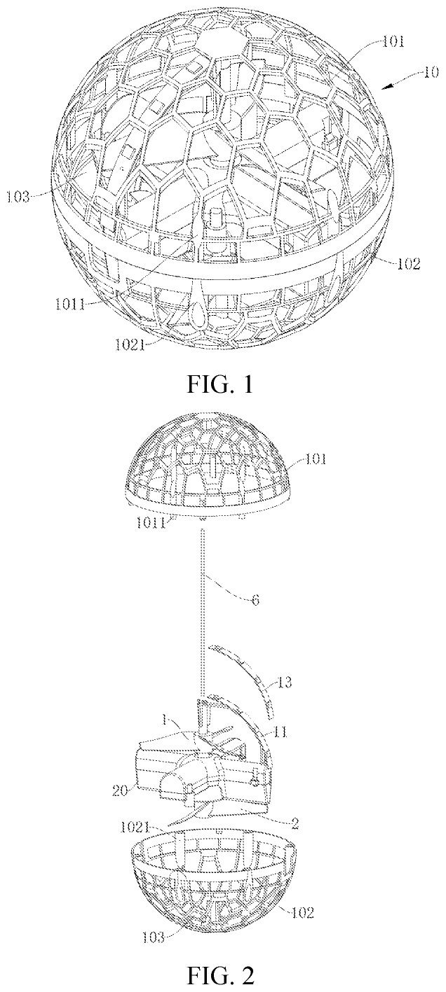

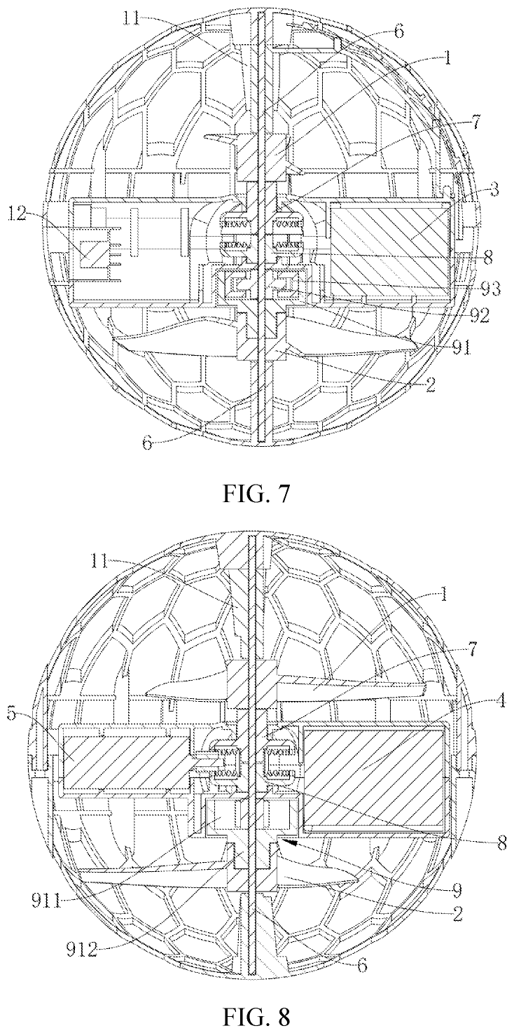

As shown in FIGS. 1-8, the present disclosure provides a spherical drone. The spherical drone comprises a main shell 10, an upper blade 1, a lower blade 2, a main control board 3, a power supply 4, a motor 5, a fixing shaft 6, a first crown gear 7, and a second crown gear 8.

The main shell 10 is spherical and defines an accommodating space. Slotted holes 103 are defined on the main shell 10. The accommodating space is communicated with an outside through the slotted holes 103. The main shell 10 comprises an upper shell 101 and a lower shell 102. The slotted holes 103 are defined on the upper shell 101 and the lower shell 102. The upper shell 101 is fastened to the lower shell 102 to form the accommodating space.

Optionally, positioning fixing columns 1011 are arranged at intervals along an edge of the upper shell 101. Positioning fixing portions 1021 matched with the positioning fixing columns 1011 are arranged at intervals along an edge of the lower shell 102. Each of the positioning fixing columns 1011 is fixed to a corresponding positioning fixing portion 1021, so that the upper shell 101 is fastened to the lower shell 102. In addition, a threaded hole is defined on each of the positioning fixing columns 1011. An abutting portion is defined in each of the positioning fixing portions 1021. When the spherical drone is assembled in place, a screw or a bolt passes through each of the positioning fixing portions 1021 and is fixed in a corresponding threaded hole, and a head of each screw or a head of each bolt abuts against a corresponding abutting portion. In addition, the slotted holes are optionally orthohexagonal holes. A shape of a regular hexagon has high stability, and shapes of other polygons in geometry may be changed, while the regular hexagon is always hexagonal. An orthohexagonal structure is able to release an introduced pressure from an external environment outward, effectively preventing damage from the external environment. The slotted holes 103 are the orthohexagonal holes, which effectively avoids falling and breaking of the spherical drone from high altitude during a flight process.

The inner support 20 is arranged in the accommodating space of the main shell 10. An accommodating cavity 203 is defined in the inner support 20. The inner support 20 comprises an upper support 201 and a lower support 202. The upper support 201 and the lower support 202 are fastened to form the accommodating cavity 203. The main control board 3, the power supply 4, the motor 5, the first crown gear 7, and the second crown gear 8 are arranged in the accommodating cavity 203. A first through hole and a second through hole are respectively defined on a top portion of the inner support 20 and a bottom portion of the inner support 20. A top portion of the first crown gear 7 protrudes from the first through hole and is fixedly connected to the upper blade 1. A bottom portion of the second crown gear 8 protrudes from the second through hole and is fixedly connected to the lower blade 2. Hook portions 2021 are arranged on the upper support 20. Clipping portions 2011 matched with the hook portion 2021 are arranged on the lower support 202, so that the upper support 201t is fastened to the lower support 202, and the main control board 3, the power supply 4, the motor 5, the first crown gear 7, and the second crown gear 8 are fixed in the accommodating cavity 203. Of course, in other embodiments, the upper support 201 and the lower support 202 are fixed through bolts or screws, which are not limited thereto. Optionally, positioning columns are arranged on the upper support 201 and positioning holes matched with the positioning columns are defined on the lower support 202, which facilitates positioning when the upper support 201 is fastened to the lower bracket 202 and improves assembly efficiency.

The fixing shaft 6 is arranged on the inner support 6. The upper blade 1 and the lower blade 2 are rotatably arranged on the fixing shaft 6. The upper blade 1 is fixed on the top portion of the first crown gear 7. The lower blade 2 is fixed on the bottom portion of the second crown gear 8. The motor 5 drives the first crown gear 7 and the second crown gear 8 to rotate, so as to simultaneously drive the upper blade 1 and the lower blade 2 to rotate. A first fixing portion is arranged on an inner top portion of the main shell 10. A second fixing portion is arranged on an inner bottom portion of the main shell 10. The first fixing portion and the second fixing portion are arranged in the accommodating space. Both of the first fixing portion and the second fixing portion comprise a fixing hole. Two ends of the fixing shaft are respectively fixed in the fixing hole of the first fixing portion and the fixing hole of the second fixing portion, so that the fixing shaft is fixedly mounted and a center the fixing shaft 6 coincides with a center of the main shell 10. Therefore, centers of the inner support 20, the first crown gear 7, the second crown gear 8, the upper blade 1, and the lower blades 2, which are sleeved on the fixing shaft 6, coincide with the center of the main shell 10, avoiding an eccentric effect of the present disclosure during the flight process, improving smoothness of the flight, and facilitates a judgment of the flight trajectory of the spherical drone.

The spherical drone further comprises a light bar 13 arranged in the accommodating space and a fixing support 11 arranged in the accommodating space. A first end of the fixing support 11 is sleeved on the fixing shaft 6 and is arranged on a top portion of the inner support 20. A second end of the fixing support 11 is fixed on the inner support 2. The light bar 13 is fixed on the fixing support 11. Therefore, when in use, the spherical drone emits colorful light. The spherical drone further comprises a charging interface 12 arranged on a side wall of the inner support 20. The charging interface 12 is electrically connected to the power supply 4. The power supply is charged through the charging interface 12. Of course, in other embodiments, the power supply 4 may be a replaceable power supply 4 that is able to be replaced for use.

Specifically, when in use, a driving gear 51 is sleeved on an output shaft of the motor 5. The driving gear 51 drives the first crown gear 7 and the second crown gear 8 to rotate. At this time, movement directions of the first crown gear 7 and the second crown gear 8 are opposite, so that a rotating direction of the upper blade 1 is opposite to a rotating direction of the lower blade 2. In addition, the upper blade 1 and the lower blade 2 comprise rotating blades. The rotating blades of the upper blade and the rotating blades of the lower blade are respectively inclined along a vertical direction of the main shell 10. An inclined direction of the rotating blades of the upper blade 1 is opposite to an inclined direction of the rotating blades of the lower blade 2. Therefore, during rotation of the upper blade 1 and the lower blade 2, a torsion generated by the rotation of the upper blade 1 is counteracted with a torsion generated by the rotation of the lower blade 2, and a downward wind forces is generated at the same time, so that the spherical drone generates an upward lift force. Therefore, after the spherical drone of the present disclosure is thrown out, the spherical drone flies stably in the sky according to the thrown angle. The upper blade 1 and the lower blade 2 are driven by the first crown gear 7 and the second crown gear 8 to rotate at the same time. When in use, a user holds the spherical drone to throw outwards at a certain angle. Under an action of a throwing force, the spherical drone flies for a certain distance along a throw-out direction. After the throwing force disappears, a flight angle of the spherical drone is kept unchanged due to the gyroscopic effect generated by rotation of the inner support 20, and the spherical drone continues to fly along the throw-out direction. That is, the user is able to predetermine a throw-out angle of the spherical drone, so that different flight trajectories are obtained. The upper blade 1 and the lower blade 2 of the present disclosure are driven, so that in a flight process of the spherical drone, a spin speed of the spherical drone is slow, and it is easy to control the spherical drone to fly in different trajectories.

### Embodiment 2

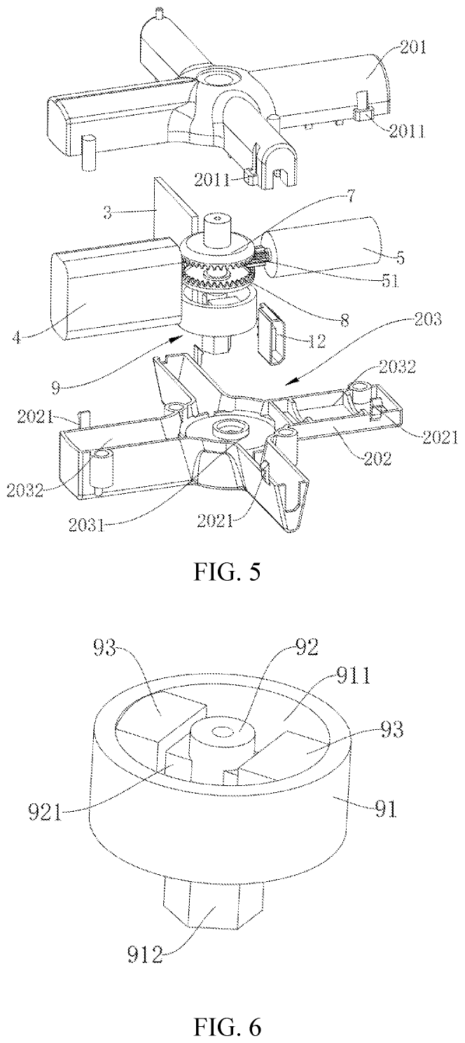

As shown in FIGS. 5-8, the embodiment of the present disclosure provides another spherical drone. The spherical drone further comprises a speed clutch gear 9 arranged on the bottom portion of the second crown gear 8. The speed clutch gear is sleeved on the fixing shaft. The lower blade 2 is fixed on a bottom portion of the speed clutch gear 9. Other structures of the spherical drone are same as that of the Embodiment 1, which is not repeated therein.

As shown in FIG. 6, the speed clutch gear 9 comprise a base 91, a shaft body 92, and two sliding blocks 93. The base 91 and the shaft body 92 are sleeved on the fixing shaft 6. A fixing groove 911 is defined on a top portion of the base 91. The shaft body 92 is arranged in the fixing groove 911. A top portion of the shaft body 92 is fixed on the bottom portion of the second crown gear 8. Mounting portions 921 are arranged on two sides of the shaft body 82. The two sliding blocks 93 are one-to-one sleeved on the mounting portions 921. A fixing attaching portion 912 is arranged on a bottom portion of the base 91, and the lower blade 2 is fixed on the fixing attaching portion 912. Of course, in other embodiments, the mounting portions 921 are respectively arranged on front, rear, left and right sides of the shaft body 92, and the sliding blocks 93 are one-to-one sleeved on the mounting portions 921. Thus, when the shaft body 92 drives the base 91 to rotate, the stability of the shaft body 92 is improved.

Specifically, when the motor 5 drives the second crown gear 8 to rotate, the second crown gear 8 drives the shaft body 92 to rotate. When a rotating speed of the shaft body 92 is low, a gap is defined between an outer side of each of the sliding blocks 93 and the base 91. Therefore, the base 91 does not rotate and the lower blade 2 does not rotate. When the rotating speed of the shaft body 92 increases and reaches a certain high speed, each of the sliding blocks 93 slides out along a direction of a corresponding mounting portion 921. When the sliding blocks 93 slide to predetermined positions, an inner side of each of the sliding blocks 93 is fixed on the corresponding mounting portion 921, and the outer side of each of the sliding blocks 93 abuts against an inner wall of the fixing groove 911. At this time, the sliding blocks 93 functions to connect the shaft body 92 and the base 91, so that the base 91 rotates along with the rotation of the shaft body 92, and the lower blade 2 arranged on the fixing attaching portion 912 rotates along with rotation of the base 91.

Therefore, during the flight process, in a low speed state, only the upper blade 1. As the speed increases, the lower blade 2 rotates in the direction opposite to the upper blade 1 at a same frequency, which increases the lift force of the spherical drone, reduces the spin speed of the spherical drone, and improves the stability of the control of the spherical drone.

Optionally, each of the sliding blocks 93 and the corresponding mounting portion 921 are magnetically attracted to each other. When the shaft body 92 rotates at a low speed, each of the sliding blocks 93 is magnetically attracted and fixed on the corresponding mounting portion 921. When the shaft body 92 rotates at a high speed, a centrifugal force of each of the sliding blocks 93 is greater than a magnetic attraction force of the corresponding mounting portion 921, and each of the sliding blocks 93 slides out along the direction of the corresponding mounting portion 921 and abuts against the inner wall of the fixing groove 91. When the speed of the shaft body 92 drops down, the centrifugal force of each of the sliding blocks 93 is less than the magnetic attraction force of the corresponding mounting portion 921, each of the sliding blocks 93 is magnetically attracted and fixed on the mounting portion 921 to reset. The lower blade 2 does not rotate under the low speed state, so that the stability of the spherical drone is improved under a condition that the lifting force is reduced, and the spherical drone has good stability when the spherical drone ascends and descends.

Optionally, the spherical drone further comprises a reset device (not shown in the drawings) arranged between each of the sliding blocks 93 and the inner wall of the fixing groove 911. Each reset device is configured to reset a corresponding sliding block 93.

The reset device may be a tension spring, a spring, a compression spring, etc., and is not limited thereto. Specifically, each reset device fixes the corresponding sliding block 93 on the corresponding mounting portion 921 by elastic force. When the rotating speed of the shaft body 92 is high, the centrifugal force of each of the sliding blocks 93 is greater than the elastic force, each of the sliding blocks 93 slides out between the shaft body 92 and the base 91 to act as a connecting rod. When the centrifugal force of each of the sliding blocks 93 is less than the elastic force, each reset device drives the corresponding sliding block 93 to reset, and the base 91 and the lower blade 2 do not rotate.

### Embodiment 3

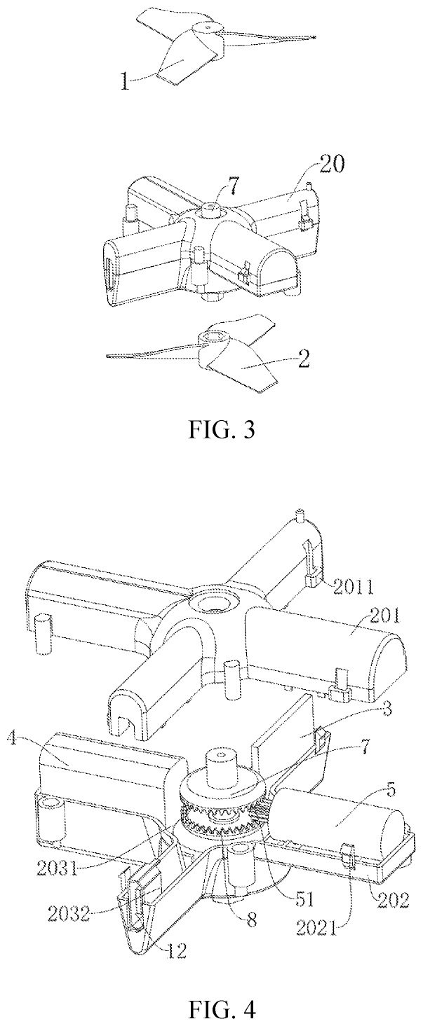

As shown in FIGS. 3-8, the embodiment of the present disclosure provides another spherical drone. The inner support 20 is a cross-shaped structure. A main cavity 2031 is defined in a middle portion of the inner support 20. Four accommodating grooves 2032 are respectively defined on four corners of the inner support 20. The four accommodating grooves 2032 are communicated with the main cavity 2031. Other structures of the spherical drone are same as that of the Embodiment 1, which is not repeated therein.

The first crown gear 7 and the second crown gear 8 are arranged in the main cavity 2031. The motor 5, the main control board 3, the power supply 4, and the charging interface 12 are respectively mounted in the four accommodating grooves 2032. As a result, gravity inside the spherical drone is balanced,

In the embodiment,, the inner support 20 is the cross-shaped structure to form the four accommodating grooves 2032, so that a gravity of the inner support 20 tends to be balanced according to the gravity effect while the motor 5, the main control board 3, the power supply 4, and the charging interface 12 are convenient to mount,

Optionally, the motor 5 and the power supply 4 are respectively arranged in a first accommodating groove 2032 and a second accommodating groove 2032. The first accommodating groove 2032 and the second accommodating groove 2032 are defined on a first column of the inner support 20. The main control board 3 and the charging interface 12 are arranged in a third accommodating groove 2032 and a fourth accommodating groove 2032. The third accommodating groove 2032 and the fourth accommodating groove 2032 are defined on a second column of the inner support 20.

Because a weight of the motor 5 and a weight of the power supply 4 are both greater than a weight of the main control board 3 and a weight of the charging interface 12, by arranging the motor 5 and the power supply 4 respectively in the first accommodating groove 2032 and the second accommodating groove 2032 defined on the first column of the inner support, and by arranging the main control board 3 and the charging interface 12 respectively in the third accommodating groove 2032 and the fourth accommodating groove 2032 defined on the second column of the inner support, a gravity of the inner support 20 tends to be balanced, avoiding the eccentricity of the spherical drone during the flight process due to the unbalanced gravity.

### Embodiment 4

The embodiment provides a control method of the spherical drone of any one of the embodiments 1-3. The control method comprises any one of steps:

Step 1: placing the spherical drone horizontally perpendicular to ground, releasing the spherical drone in a rotating state, placing a palm of a human body at a position of 1-5 cm below a bottom portion of the spherical drone, so that the spherical drone is suspended in the palm; slowly moving the palm, so that the spherical drone moves along with the palm;

Step 2: holding the spherical drone with one hand, placing the spherical drone horizontally; titling the spherical drone by 10-70° with respect to a target position; releasing the spherical drone in the rotating state, so that the spherical drone flies to the target position

Step 3: holding the spherical drone with the one hand, tilting the spherical drone by 10-70° towards a lower left direction or a lower right direction, enabling the spherical drone to fly away towards a left front direction or a right front direction, so that the spherical drone flies back to another target position along an offset direction;

Step 4: holding the spherical drone with the one hand; throwing the spherical drone in an upward direction of 1-50°, so that the spherical drone flies back according to a downward direction opposite to the upward direction; and

Step 5: holding the spherical drone with the one hand, tilting the spherical drone by 10-50° towards the left front direction or the right front direction, enabling the spherical drone to fly away towards the left front direction or the right front direction, so that the spherical drone flies back to another target position along the offset direction.

When the spherical drone is in use, a switch is first switched to an ON position, then the spherical drone is shaken up and down. After 2 seconds, the upper blade 1 and the lower blade 2 rotate, so that the spherical drone has the lift force, and the user is able to use any one of the foregoing control steps to throw the spherical drone at a certain angle, and the spherical drone will rotate according to a certain trajectory. When the spherical drone is placed in the hand for more than 15 seconds, the spherical drone automatically enters a sleep state.

The above embodiments are optional embodiments of the present disclosure, but the embodiments of the present disclosure are not limited by the foregoing embodiments, and any other changes, modifications, substitutions, combinations, and simplification made without departing from the spirit and principle of the present disclosure should be regarded as equivalent replacement manners, which are all included within the protection scope of the present disclosure.

What is claimed is:

1. A spherical drone, comprising:
a main shell defines an accommodating space,
an inner support arranged in the accommodating space,
a main control board,
a power supply,
a motor,
a fixing shaft arranged on the inner support,
an upper blade and an lower blade rotatably arranged on the fixing shaft, and
a first crown gear and a second crown gear arranged on the inner support;
wherein the main shell is spherical; slotted holes are defined on the main shell; the accommodating space is communicated with an outside through the slotted holes; the main control board, the power supply, and the motor are mounted on the inner support; a center of the fixing shaft coincides with a center of the main shell; the first crown gear and the second crown gear are sleeved on the fixing shaft; the upper blade is fixed on a top portion of the first crown gear; the lower blade is fixed on a bottom portion of the second crown gear; the motor drives the first crown gear and the second crown gear to rotate, so as to simultaneously drive the upper blade and the lower blade to rotate.

2. The spherical drone according to claim 1, wherein the spherical drone further comprises a speed clutch gear arranged on the bottom portion of the second crown gear; the speed clutch gear is sleeved on the fixing shaft; the lower blade is fixed on a bottom portion of the speed clutch gear.

3. The spherical drone according to claim 2, wherein the speed clutch gear comprise a base and a shaft body; a fixing groove is defined on the base; the base is sleeved on the fixing shaft; the shaft body is arranged in the fixing groove and is sleeved on the fixing shaft; the shaft body is fixed on the bottom portion of the second crown gear; mounting portions are arranged on two sides of the shaft body; and two sliding blocks are one-to-one sleeved on the mounting portions; a fixing attaching portion is arranged on a bottom portion of the base; the lower blade is arranged on the fixing attaching portion;
when a rotating speed of the shaft body is low, a gap is defined between an outer side of each of the sliding blocks and the base; when the rotating speed of the shaft body is high, each of the sliding blocks slides out along a direction of a corresponding mounting portion; when the sliding blocks slide to predetermined positions, an inner side of each of the sliding blocks is fixed on the corresponding mounting portion, and the outer side of each of the sliding blocks abuts against an inner wall of the fixing groove, so that the base is driven to rotate.

4. The spherical drone according to claim 3, wherein each of the sliding blocks and the corresponding mounting portion are magnetically attracted to each other.

5. The spherical drone according to claim 3, wherein the spherical drone further comprises a reset device arranged between each of the sliding blocks and the inner wall of the fixing groove; each reset device is configured to reset a corresponding sliding block.

6. The spherical drone according to claim 1, wherein the spherical drone further comprises a light bar arranged in the accommodating space and a fixing support arranged in the accommodating space; a first end of the fixing support is sleeved on the fixing shaft and is arranged on a top portion of the inner support; a second end of the fixing support is fixed on the inner support; the light bar is fixed on the fixing support.

7. The spherical drone according to claim 1, wherein the upper blade and the lower blade comprise rotating blades; the rotating blades of the upper blade and the rotating blades of the lower blade are respectively inclined along a vertical direction of the main shell; an inclined direction of the rotating blades of the upper blade is opposite to an inclined direction of the rotating blades of the lower blade.

8. The spherical drone according to claim 1, wherein an accommodating cavity is defined in the inner support; the main control board, the power supply, the motor, the first crown gear, and the second crown gear are arranged in the accommodating cavity.

9. The spherical drone according to claim 8, wherein the spherical drone further comprises a charging interface arranged on a side wall of the inner support; the charging interface is electrically connected to the power supply.

10. The spherical drone according to claim 9, wherein the inner support is a cross-shaped structure; a main cavity is defined in a middle portion of the inner support; four accommodating grooves are respectively defined on four corners of the inner support; the four accommodating grooves are communicated with the main cavity; the first crown gear and the second crown gear are arranged in the main cavity; the motor, the main control board, the power supply, and the charging interface are respectively mounted in the four accommodating grooves.

11. The spherical drone according to claim 10, wherein the motor and the power supply are respectively arranged in a first accommodating groove and a second accommodating groove; the first accommodating groove and the second accommodating groove are defined on a first column of the inner support; the main control board and the charging interface are arranged in a third accommodating groove and a fourth accommodating groove; the third accommodating groove and the fourth accommodating groove are defined on a second column of the inner support.

12. The spherical drone according to claim 8, wherein the inner support comprises an upper support and a lower support; the upper support and the lower support are fastened to form the accommodating cavity.

13. The spherical drone according to claim 12, wherein positioning columns are arranged on the upper support; positioning holes matched with the positioning columns are defined on the lower support.

14. The spherical drone according to claim 12, wherein hook portions are arranged on the upper support; clipping portions matched with the hook portion are arranged on the lower support.

15. The spherical drone according to claim 1, wherein a first fixing portion is arranged on an inner top portion of the main shell; a second fixing portion is arranged on an inner bottom portion of the main shell; the first fixing portion and the second fixing portion are arranged in the accommodating space; both of the first fixing portion and the second fixing portion comprise a fixing hole; two ends of the fixing shaft are respectively fixed in the fixing hole of the first fixing portion and the fixing hole of the second fixing portion.

16. The spherical drone according to claim 15, wherein the main shell comprises an upper shell and a lower shell; the slotted holes are defined on the upper shell and the lower shell; the upper shell is fastened to the lower shell to form the accommodating space; the first fixing portion is arranged on the upper shell; the second fixing portion is arranged on the lower shell.

17. The spherical drone according to claim 16, wherein the slotted holes are orthohexagonal holes.

18. The spherical drone according to claim 16, wherein positioning fixing columns are arranged at intervals along an edge of the upper shell; positioning fixing portions matched with the positioning fixing columns are arranged at intervals along an edge of the lower shell; a threaded hole is defined on each of the positioning fixing columns; an abutting portion is defined in each of the positioning fixing portions; when the spherical drone is assembled in place, a screw or a bolt passes through each of the positioning fixing portions and is fixed in a corresponding threaded hole; a head of each screw or a head of each bolt abuts against a corresponding abutting portion, so that the upper shell is fixed to the lower shell.

19. A control method of the spherical drone according to claim 1, comprising:
any one of steps:
placing the spherical drone horizontally perpendicular to ground; releasing the spherical drone in a rotating state; placing a palm of a human body at a position of 1-5 cm below a bottom portion of the spherical drone, so that the spherical drone is suspended in the palm; slowly moving the palm, so that the spherical drone moves along with the palm;
holding the spherical drone with one hand; placing the spherical drone horizontally; titling the spherical drone by 10-70° with respect to a target position; releasing the spherical drone in the rotating state, so that the spherical drone flies to the target position;
holding the spherical drone with the one hand; tilting the spherical drone by 10-70° towards a lower left direction or a lower right direction; enabling the spherical drone to fly away towards a left front direction or a right front direction, so that the spherical drone flies back to another target position along an offset direction;
holding the spherical drone with the one hand; throwing the spherical drone in an upward direction of 10-50°, so that the spherical drone flies back according to a downward direction opposite to the upward direction; and
holding the spherical drone with the one hand; tilting the spherical drone by 10-50° towards the left front direction or the right front direction; enabling the spherical drone to fly away towards the left front direction or the right front direction, so that the spherical drone flies back to another target position along the offset direction.
